(19) United States
(12) Patent Application Publication
(10) Pub. No.: US 2007/0285356 A1
(43) Pub. Date: Dec. 13, 2007

(54) Plasma display apparatus

(75) Inventors: Seong Nam Ryu, Busan-si (KR); Woo Gon Jeon, Gumi-si (KR); Sang Min Hong, Seoul (KR); Woo Tae Kim, Yongin-si (KR); Kyung A. Kang, Busan-si (KR); Jeong Hyun Hahm, Gumi-si (KR); Jae Sung Kim, Gumi-si (KR)

Correspondence Address: KED & ASSOCIATES, LLP, P.O. Box 221200, Chantilly, VA, 20153-1200, US

(73) Assignee: LG Electronics Inc.

(21) Appl. No.: 11/646,591

(22) Filed: Dec. 28, 2006

(30) Foreign Application Priority Data
Jun. 13, 2006 (KR) 10-2006-0053145

(51) Int. Cl. G09G 3/28

(52) U.S. Cl. 345/71

(57) ABSTRACT

The present invention relates to a plasma display apparatus. The plasma display apparatus includes an upper substrate, a scan electrode, a sustain electrode, a dielectric layer, a lower substrate, and address electrodes. The scan and sustain electrodes are formed on the upper substrate, and the dielectric layer covers the scan and sustain electrodes. The lower substrate faces the upper substrate, and the address electrodes are formed on the lower substrate. In plasma display apparatus, at least one of the scan and sustain electrodes is formed as one layer. A reset signal including a gradually falling setdown period is supplied to the scan electrode more than two times in at least one reset period among a plurality of subfields.

This Nonprovisional application claims priority under 35 U.S.C. § 119(a) on Patent Application No. 10-2006-0053145 filed in Korea on Jun. 13, 2006, the entire contents of which are hereby incorporated by reference.

### BACKGROUND OF THE INVENTION

1. Field of the Invention

The present invention relates to a plasma display apparatus, and more particularly, to a panel for a plasma display apparatus.

2. Description of the Background Art

In a plasma display panel, barrier ribs formed between an upper substrate and a lower substrate form one unitary cell. The unit cell is filled with a main discharge gas such as neon (Ne), helium (He), and a mixture (Ne+He) of neon and helium and an inert gas containing a small amount of xenon (Xe). When a discharge is induced using a high level voltage, the inert gas generates vacuum ultraviolet rays and excites phosphors formed between barrier ribs, thereby embodying an image. Since the plasma display panel can be made thin and light-weighted, the plasma display apparatus is attracting attention as a next generation display apparatus.

FIG. 1 is a diagram of a plasma display panel according to the related art.

As shown in FIG. 1, the plasma display panel includes an upper panel 100 and a lower panel 110. The upper panel 100 has a scan electrode 102 and a sustain electrode 103 paired on an upper substrate 101, which is a display surface for displaying an image thereon. The lower panel 110 includes a plurality of address electrodes 113 arranged to intersect with a plurality of sustain electrode pairs on a lower substrate 111, which is a rear surface. The lower panel 110 is spaced apart in parallel and is sealed to the upper panel 100.

The upper panel 100 includes the scan electrode 102 and the sustain electrode 103 formed as a pair. The scan electrode 102 and the sustain electrode 103 include transparent electrodes 102a and 103a made of indium-tin-oxide (ITO) and bus electrodes 102b and 103b. The scan electrode 102 and the sustain electrode 103 are covered with an upper dielectric layer 104, and a protective layer 105 is formed on the upper dielectric layer 104.

The lower panel 110 includes barrier ribs 112 for partitioning a discharge cell. A plurality of address electrodes 113 are arranged in parallel with the barrier ribs 112. Red (R), green (G), and blue (B) phosphors are coated on the address electrodes 113. A lower dielectric layer 115 is formed between the address electrode 113 and the phosphors 114.

In the plasma display panel according to the related art, the transparent electrodes 102a and 103a forming the scan electrode 102 and the sustain electrode 103 are formed of expensive material, ITO. The transparent electrodes 102a and 103a cause an increase of a manufacturing cost of the plasma display panel. Therefore, a great attention is drawn to manufacturing a plasma display panel reducing a manufacturing cost and guaranteeing a visual characteristic and a driving characteristic enough for user's viewing.

### SUMMARY OF THE INVENTION

Accordingly, an aspect of the present invention is to solve at least the problems and disadvantages of the background art.

The present invention is to provide a plasma display apparatus from which a transparent ITO electrode is eliminated, thereby reducing a manufacturing cost of a plasma display panel, and improving flickering of a display image and generation of a bright defect.

To achieve theses and other advantages and in accordance with an aspect of the present invention, as embodied and broadly described, there is provided a plasma display apparatus includes an upper substrate, a scan electrode, a sustain electrode, a dielectric layer, a lower substrate, and address electrodes. The scan and sustain electrodes are formed on the upper substrate, and the dielectric layer covers the scan and sustain electrodes. The lower substrate faces the upper substrate, and the address electrodes are formed on the lower substrate.

In the plasma display apparatus, at least one of the scan and sustain electrodes may be formed as one layer. A reset signal including a gradually falling setdown period may be supplied to the scan electrode more than two times in at least one reset period among a plurality of subfields.

In accordance with another aspect of the present invention, there is provided a plasma display apparatus in which at least one of the scan and sustain electrodes are formed as one layer, and in at least one reset period among a plurality of subfields, after supplying a reset signal having a gradually falling setdown period to the scan electrode more than once, a first signal rising as much as a first voltage is supplied to the scan electrode before a scan signal having a negative voltage is supplied to the scan electrode.

In accordance with a further another aspect of the present invention, there is provided a plasma display apparatus in which at least one of the scan and sustain electrodes formed as one layer. In at least one reset period among a plurality of subfields, a reset signal having a gradual falling setdown period may be supplied to the scan electrode more than once, and in at least one reset period among the plurality of subfields, the reset signal may be not supplied to the scan electrode.

### BRIEF DESCRIPTION OF THE DRAWINGS

The invention will be described in detail with reference to the following drawings in which like numerals refer to like elements.

FIG. 1 is a diagram illustrating a panel of a plasma display apparatus according to the related art;

FIG. 2 is a perspective view illustrating a plasma display panel according to an exemplary embodiment of the present invention;

FIG. 3 is a cross-section view illustrating a plasma display panel to show arrangement of electrodes according to an exemplary embodiment of the present invention;

FIG. 4 is a timing diagram illustrating a method for driving a plasma display panel in a time-division manner by dividing one frame into a plurality of subfields according to an exemplary embodiment of the present invention;

FIGS. 5A and 5B are timing diagrams illustrating driving signals for driving a plasma display panel according to exemplary embodiments of the present invention.

FIG. 6 is a cross-sectional view illustrating a sustain electrode of a plasma display panel according to a first exemplary embodiment of the present invention;

FIG. 7 is a cross-sectional view illustrating a sustain electrode according to a second exemplary embodiment of the present invention;

FIG. 8 is a cross-sectional view illustrating a sustain electrode according to a third exemplary embodiment of the present invention;

FIG. 9 is a cross-sectional view illustrating a sustain electrode according to a fourth exemplary embodiment of the present invention;

FIG. 10 is a cross-sectional view illustrating an electrode structure of a plasma display panel according to a fifth exemplary embodiment of the present invention;

FIG. 11 is a cross-sectional view illustrating an electrode structure of a plasma display panel according to a sixth exemplary embodiment of the present invention;

FIG. 12 is a cross-sectional view illustrating an electrode structure of a plasma display panel according to a seventh exemplary embodiment of the present invention;

FIG. 13 is a cross-sectional view illustrating an electrode structure of a plasma display panel according to an eighth exemplary embodiment of the present invention;

FIG. 14 is a cross-sectional view illustrating an electrode structure of a plasma display panel according to a ninth exemplary embodiment of the present invention;

FIG. 15 is a cross-sectional view illustrating an electrode structure of a plasma display panel according to a tenth exemplary embodiment of the present invention; and

FIGS. 16A and 16B are cross-sectional views illustrating an electrode structure of a plasma display panel according to an eleventh exemplary embodiment of the present invention.

### DETAILED DESCRIPTION OF PREFERRED EMBODIMENTS

Preferred embodiments of the present invention will be described in a more detailed manner with reference to the drawings.

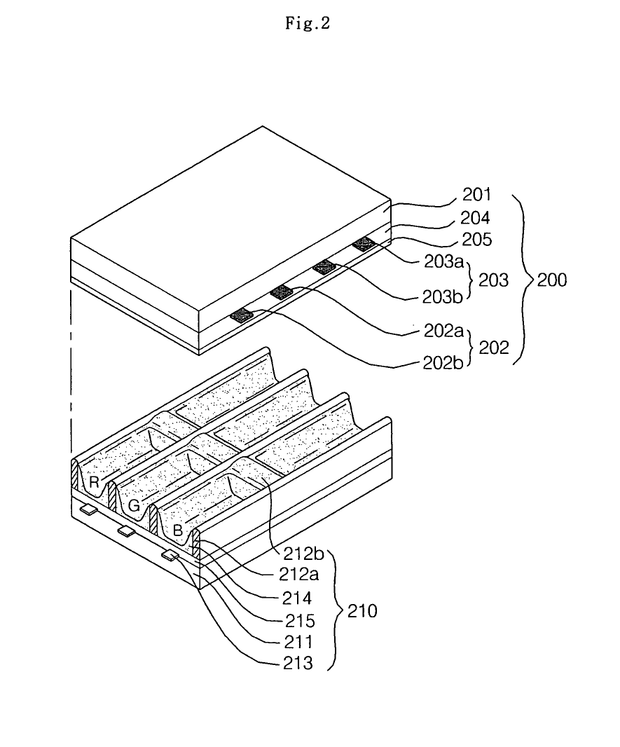

FIG. 2 is a perspective view illustrating a structure of a plasma display panel according to an exemplary embodiment of the present invention.

Referring to FIG. 2, the plasma display panel includes an upper panel 200 and a lower panel 210 sealed at a predetermined distance. The plasma display panel also includes address electrodes 213 formed on a lower substrate 211 in the direction of intersecting with a sustain electrode pair 202 and 203, and barrier ribs 212a and 212b formed on the lower substrate 211 and partitioning a plurality of discharge cells.

The upper panel 200 includes sustain electrodes 202 and 203 formed on an upper substrate 201 by pair. The sustain electrode pair 202 and 203 are classified into a scan electrode 202 and a sustain electrode 203 depending on its function. The sustain electrode pair 202 and 203 is covered by a upper dielectric layer 204 for limiting a discharge current and insulating between the electrode pair. A protective layer 205 is formed on the upper dielectric layer 204. The protective layer 205 protects the upper dielectric layer 204 from sputtering of charged particles generated at the time of gas discharge and enhances an emission efficiency of secondary electrons.

The lower panel 210 includes barrier ribs 212a and 212b formed on the lower substrate 211 for partitioning a plurality of discharge spaces, that is, discharge cells. Address electrodes 213 are arranged in the direction of intersecting with the sustain electrode pair 202 and 203. A phosphor layer 214 is coated on the barrier ribs 212a and 212b and the lower dielectric layer 215. The phosphor layer 214 is excited by ultraviolet rays generated in the gas discharge, and generates visible rays.

The barrier ribs 212a and 212b include vertical barrier ribs 212a formed in parallel with the address electrodes 213, and horizontal barrier ribs 212b formed in the direction of intersecting with the address electrodes 213. The barrier ribs 212a and 212b physically divide the discharge cells and prevent ultraviolet ray and visible ray from leaking to adjacent discharge cells.

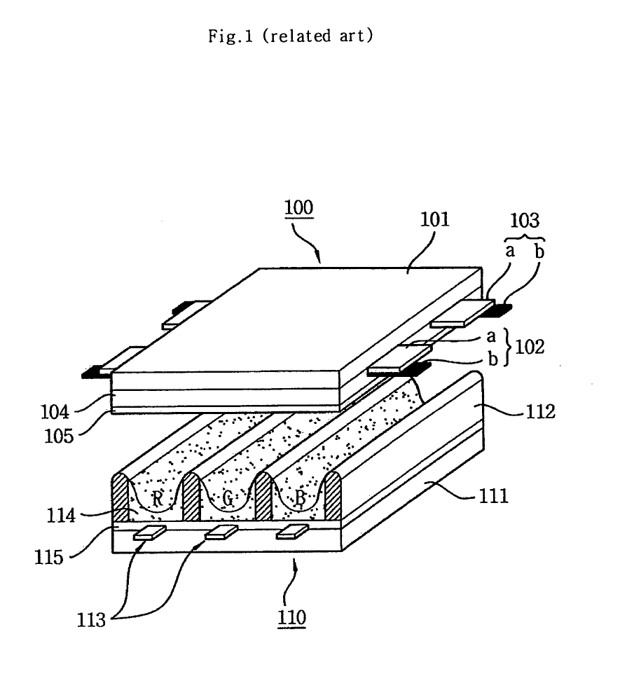

In the plasma display panel according to the present embodiment, the sustain electrode pair 202 and 203 are formed of only opaque metal electrodes unlike the conventional sustain electrode pair 102 and 103 shown in FIG. 1. That is, the transparent material ITO is not used. The sustain electrode pair 202 and 203 is formed of conventional bus electrode material such as silver (Ag), copper (Cu) or chrome (Cr). That is, the sustain electrode pair 202 and 203 of the plasma display panel according to the present embodiment is constituted of the bus electrode of one layer, not the conventional ITO electrode.

For example, in the present embodiment, it is desirable that each of the sustain electrode pair 202 and 203 is made of silver having a photosensitive property. Also, it is desirable that each of the sustain electrode pair 202 and 203 according to the embodiment of the present invention has a property of darker color and lower light transmission than those of the upper dielectric layer 204 formed on the upper substrate 201.

It is desirable that the thickness of electrode lines 202a, 202b, 203a and 203b have thicknesses of about 2 μm to 8 μm. When the electrode lines 202a, 202b, 203a and 203b having thicknesses of the above range can provide a resistance range and an aperture ratio making a normal operation of the plasma display panel possible. Thus, the electrode lines can be prevented from blocking lights reflected and coming out from a front surface of plasma display apparatus, and decreasing a luminance. Also, a capacitance of the plasma display panel does not greatly increase. It is desirable that the electrode lines 202a, 202b, and 203a, 203b have resistances of about 50 to 60Ω, having thicknesses of about 2 μm to 8 μm.

The respective red (R), green (G), and blue (B) phosphor layers 214 can be equal to or different from each other in width. When the phosphor layers 214 of the R, G, B discharge cells are different from each other in width, the phosphor layer 214 of the G or B discharge cell can be greater in width than the phosphor layer 214 of the R discharge cell.

As shown in FIG. 2, it is desirable that the sustain electrodes 202 and 203 are formed by a plurality of electrode lines within one discharge cell, respectively. That is, it is desirable that the first sustain electrode 202 is formed by two electrode lines 202a and 202b, and the second sustain electrode 203 is formed by two electrode lines 203a and 203b and is disposed in symmetry with the first sustain electrode 202 on the basis of a center of the discharge cell. It is desirable that the first and second sustain electrodes 202 and 203 are a scan electrode and a sustain electrode, respectively.

This considers the aperture ratio and a discharge diffusion efficiency according to the use of the opaque sustain electrode pair 202 and 203. In order words, the first and second sustain electrodes 202 and 203 use the electrode lines of narrow widths considering the aperture ratio, and uses the electrode lines in plural considering the discharge diffusion efficiency. It is desirable that the number of the electrode lines is decided considering the aperture ratio and the discharge diffusion efficiency at the same time.

Each of the electrode lines 202a, 202b, 203a and 203b can be formed on a predetermined black layer (not shown), not in direct contact with the upper substrate 201. In other words, the black layer can be formed between the upper substrate 201 and the respective electrode lines 202a, 202b, and 203a, 203b, thereby improving a discoloration phenomenon of the upper substrate 201, which is caused by a direct contact between the upper substrate 201 and the respective electrode lines 202a, 202b, and 203a, 203b.

The structure of the plasma display panel of FIG. 2 merely is one exemplary embodiment of the present invention and thus, the present invention is not limited to the structure of the plasma display panel of FIG. 2. For example, a black matrix (BM) can be formed on the upper substrate 201 to perform a light blocking function of absorbing external light and reducing its reflection and a function of improving a contrast of the upper substrate 201. In the black matrix, separate and integral BM structures all are possible.

In formation, the black matrix can be formed at the same time with the black layer to be physically connected, or can be formed at a different time from the black layer to be physically disconnected. In case of forming the black matrix and the black layer to be physically connected, the black matrix and the black layer are formed using the same material. On the contrary, in case of forming the black matrix and the black layer to be physically disconnected, different materials are used.

Although FIG. 2 shows a close type barrier rib structure in which the discharge cells have a closed structure by the vertical barrier ribs 212a and the horizontal barrier ribs 212b, barrier ribs may be formed as a stripe type having only a vertical barrier rib, or a fish bone type in which a protrusion part is formed on a vertical barrier rib at a distance.

Also, the barrier ribs may be formed in various shapes in addition to the barrier rib structure shown in FIG. 2. For example, the barrier rib structure may be a differential type barrier rib structure that include vertical barrier ribs 212a and horizontal barrier ribs 213a which have different heights, a channel barrier rib structure that includes at least one of channels as an exhaust passages at the vertical barrier ribs 212a and the horizontal barrier ribs 213a, and a hollow barrier rib structure that include at least one of hollows formed at one of the vertical barrier ribs and the horizontal barrier ribs. Herein, in the differential type barrier structure, it is desirable that the horizontal barrier ribs 212b are higher than the vertical barrier ribs 212a. Also, it is desirable that the channel or the hollow may be formed at the horizontal barrier ribs 212b rather than the vertical barrier ribs 212a in the channel barrier rib structure and the hollow barrier rib structure.

Although the R, G, and B discharge cells are formed on the same line in the present embodiment, the R, G and B discharge cells may be arranged in a different shape. For example, the R, G and B discharge cells can be arranged in a triangle shape, that is, a delta type. Also, the R, G and B discharge cells can be arranged in a rectangle shape, a pentagon shape, and a hexagonal shape.

Also, the widths of the vertical barrier ribs 212a and the horizontal barrier ribs 212b may be different from each other, and the width of the barrier ribs may be a top width or a bottom width. Also, it is desirable that the width of the horizontal barrier rib 212b is about 1.0 to 5.0 times of the width of the vertical barrier wall 212a.

In the plasma display panel according to the present embodiment, the pitches of the R, G and B discharge cells in the plasma display panel according to the present embodiment are substantially identical. However, the R, G, and B discharge cells can also have different pitches to adjust a color temperature in the R, G, and B discharge cells. The R, G, B discharge cells can all have different pitches, but only the discharge cell expressing one color among the R, G, B discharge cells can have a different pitch. For example, it is possible that the R discharge cell has the smallest pitch, and the G and B discharge cells have greater pitches than the R discharge cell.

Although the address electrodes formed on the lower substrate 211 can be substantially constant in width or thickness, a width or thickness of the address electrodes within the discharge cell can be different from the that of the outside of the discharge cell. For example, its width or thickness within the discharge cell can be greater than that of the outside of the discharge cell.

It is desirable that the barrier rib 121 does not uses lead (Pb), or contains, though any, less lead (Pb) of 0.1 weight % or less of a total weight of the plasma display panel, or 1000 parts per million (PPM) or less.

When a total percentage of a lead component is 1000 PPM or less, a lead percentage versus the weight of the plasma display panel can be 1000 PPM or less.

Alternately, it is also possible to provide a percentage of the lead component of a specific constituent element of the plasma display panel, by 1000 PPM or less. For example, a lead percentage of the barrier rib, a lead percentage of the dielectric layer, or a lead percentage of the electrode versus each weight of the constituent elements (the barrier rib, the dielectric layer, and the electrode) can be 1000 PPM or less.

It is also possible to provide lead percentages of all constituent elements such as the barrier walls, dielectric layers, the electrodes and the phosphor layers versus the weight of the plasma display panel, by 1000 PPM or less. The reason why a total percentage of a lead component is set to 1000 PPM or less as above is that the lead component can have a bad influence on a human body.

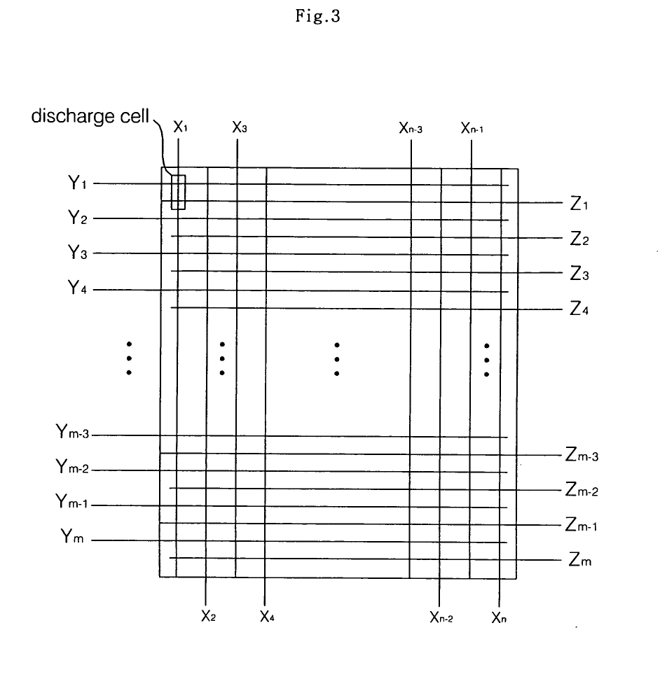

FIG. 3 is a diagram illustrating an arrangement of electrodes in a plasma display panel according to an exemplary embodiment of the present invention.

As shown in FIG. 3, it is desirable that the plurality of discharge cells in the plasma display panel are arranged in a matrix form. The plurality of discharge cells are provided at intersections of scan electrode lines (Y₁ to Yₘ), sustain electrode lines (Z₁ to Zₘ), and the address electrodes (X₁ to Xₙ). The scan electrode lines (Z₁ to Zₘ) are sequentially driven, and the sustain electrode lines (Z₁ to Zₘ) are commonly driven. The address electrode lines (X₁ to Xₙ) are divided into odd number lines and even number lines, and are driven.

The electrode arrangement of FIG. 3 merely is one exemplary embodiment of the present invention and thus, the present invention is not limited to the electrode arrangement shown in FIG. 3. For example, it is possible to use a dual scan type or a double scan type in which two of the scan electrode lines (Y₁ to Yₘ) are driven at the same time. In the dual scan type, a plasma display panel is divided into two regions, an upper region and a lower region, one scan electrode line in each of the upper and lower regions is driven at the same time. In the double scan type, two consecutively-arranged scan lines are driven at the same time.

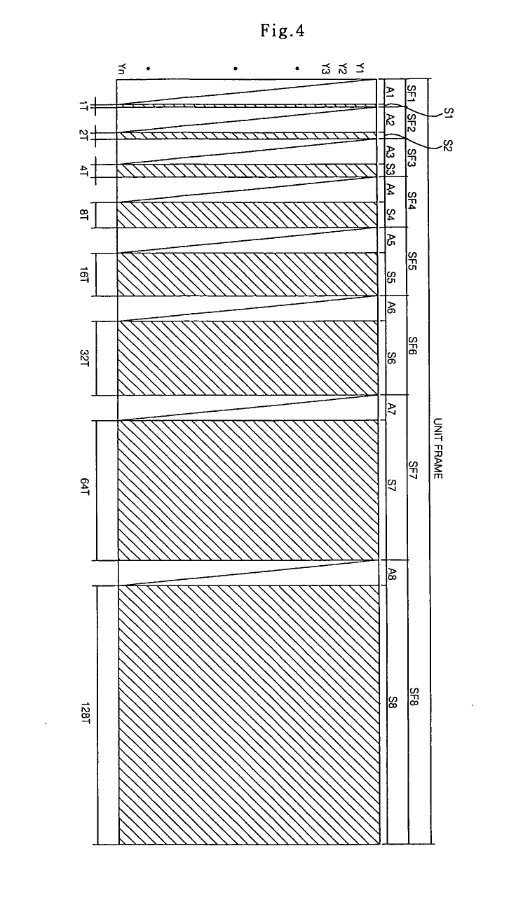

FIG. 4 is a timing diagram for describing a method for dividing one frame into a plurality of subfields and driving a plasma display panel in a time-division manner.

The unit frame may be divided into a predetermined number of subfields, for example, eight subfields (SF1, . . . , SF8), to realize a time-division gray level expression. Each of the subfields is divided into a reset period (not shown), address periods (A1, . . . , A8) and a sustain periods (S1, . . . , S8).

In each of the address periods (A1, . . . , A8), a display data signal is applied at an address electrode X, and a corresponding scan pulse is sequentially supplied to each of scan electrodes Y.

In each of the sustain periods (S1, . . . , S8), a sustain pulse is alternatively supplied to the scan electrode Y and the sustain electrode Z, and a sustain discharge is induced in the discharge cells where wall charges are formed in the address (A1, . . . , A8).

The luminance of the plasma display panel is proportional to the number of sustain discharging pulses within the sustain discharging period (S1, . . . , S8) in a unit frame. When one frame forming one image is expressed by 8 subfields and 256 gray levels, different number of sustain pulses can be sequentially assigned in rates of 1:2:4:8:16:32:64: and 128 in each subfield. In order to obtain a luminance of 133 gray levels, the discharge cells are addressed during the subfield 1, the subfield 3 and the subfield 8, and the sustain discharge is performed.

The number of sustain discharging in each of the allocated subfields can be dynamically decided depending on the weights of subfields based on an automatic power control (APC) step. That is, FIG. 4 exemplarily shows that one frame is divided into 8 subfields. However, the present invention is not limited thereto. The number of subfields in one frame may vary according to designing specifications. For example, one frame may be divided into more or less of eight subfields like twelve or sixteen subfields to drive a plasma display panel.

It is possible to variously change the number of sustain discharge pulses assigned in each subfield in consideration of a gamma characteristic and a panel characteristic. For example, the gray level assigned in the subfield 4 can decrease from 8 to 6, and the gray level assigned in the subfield 6 can increases from 32 to 34.

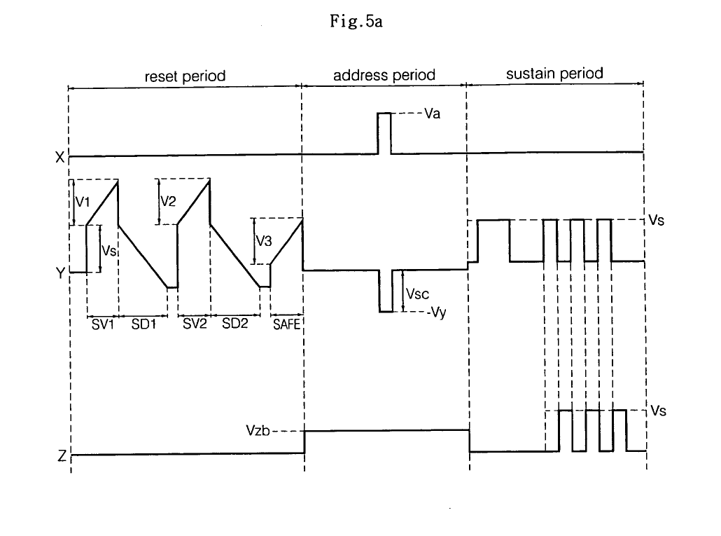

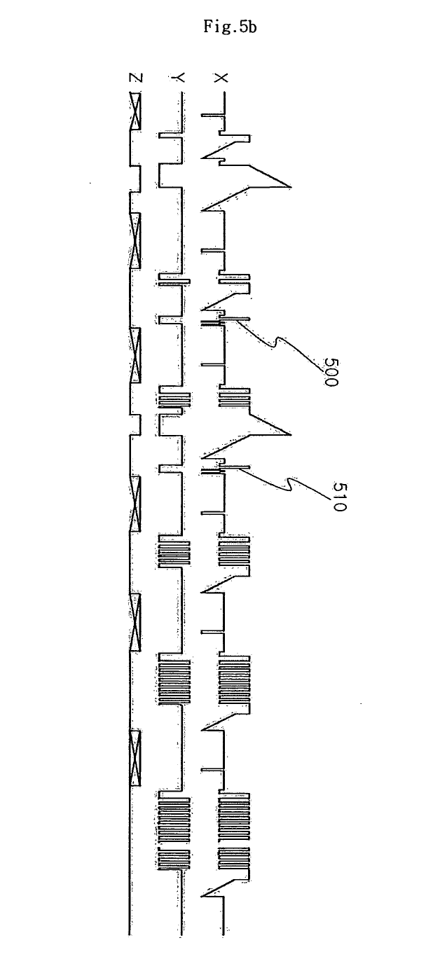

FIG. 5A is a timing diagram illustrating driving signals for driving a plasma display panel during the divided subfield according to an exemplary embodiment of the present invention.

Each of the subfields includes a reset period for initializing discharge cells in an entire screen, an address period for selecting discharge cells, and a sustain period for sustaining the discharge of the selected discharge cells.

As shown in FIG. 5A, according to a driving signal of a plasma display panel according to the present embodiment, two reset signals are sequentially supplied to a scan electrode Y in the reset period, and then a gradually rising SAFE signal is supplied to the scan electrode Y.

Each of two reset signals includes a setup period (SU1, SU2), and a setdown period (SD1, SD2). In the setup period (SU1, SU2), the setup signal that is gradually increasing as much as V1 or V2 is supplied to all scan electrode Y at the same time, thereby inducing a minute discharging in all the discharge cells. Accordingly, the wall discharges are generated. The voltages V1 and V2 of the two reset signals may be same or different. For example, the voltage V1 can be higher than the voltage V2.

In the setdown period (SD1, SD2), a setdown signal that is gradually falling from a positive voltage lower than a peak voltage of the setup signal is supplied to all the scan electrode Y at the same time, thereby inducing an erase discharge at all the discharge cells. Accordingly, unnecessary ones of the wall charges and space charges generated by a setup discharge are erased, thereby uniformly leaving the wall charges required for address discharge in discharge cells.

When the reset signal is supplied to the scan electrode Y only one time, wall charges for address discharge may be improperly left at all the discharge cells due to the instability of the plasma display panel. Accordingly, as like the driving signal in the present embodiment, the reset signal is supplied twice in order to set the wall charges at all the discharge cells to be proper for address discharge. Therefore, the generation of bright defect can be reduced by supplying the reset pulse twice.

It is desirable that the voltage levels V₁ and V₂ for the reset signal rising during the setup period (SU, SU2) are about 160V to 250V. It is more desirable that the voltage levels V₁ and V₂ are about 190V to 250V. When the rising voltages V₁ and V₂ have the above voltage range, the bright defect generation can be reduced within a range greatly increasing a power consumption, and the flicker phenomena can be improved.

The driving signals shown in FIG. 5A merely are one exemplary embodiment of the present invention and thus, more than three reset signals can be sequentially supplied to a scan electrode Y.

It is desirable that the reset pulse is supplied to a scan electrode Y twice in the first subfield among a plurality of subfields for division-driving the frame as shown in FIG. 5A. Furthermore, in consideration of driving margin and contrast of a plasma display panel, it is desirable that the driving signals are supplied only in the first subfield of one frame as shown in FIG. 5A, or they are applied in the first subfield and an about middle subfield among subfields in one frame.

As shown in FIG. 5A, a positive safe signal (SAFE), which is gradually rising as much as V₃ after supplying the second reset signal, is supplied to a scan electrode Y based on the driving signal of the plasma display panel according to the present invention. The safe signal (SAFE) induces minute discharge to form desired wall charges in the discharge cells. In more detail, a negative wall charge is formed at a scan electrode Y included in the most of discharge cells during the setdown period SD2. However, a positive wall charge can be formed at a scan electrode Y in some discharge cells. Therefore, the gradually rising positive safe signal is supplied to a scan electrode Y so as to form a negative wall charge at all scan electrode Y. That is, the safe signal SAFE induces the negative wall charge at the scan electrodes Y where the positive wall charge is formed during the setdown period SD2.

Although the safe signal having a gradually increasing voltage value is shown in FIG. 5A, safe signals 500 and 510 having an abruptly rising voltage value may be supplied as shown in FIG. 5B.

As shown in FIG. 5B, the reset signal can be supplied to a scan electrode in only predetermined subfields among a plurality of subfields. A predetermined voltage can be supplied to an address electrode during only a setup period in the reset period. For example, an address voltage (Va) is supplied to the address electrode.

The maximum voltage of a reset signal can vary depending on a temperature. For example, a reset voltage at a high temperature or a low temperature can be set to be higher than a reset voltage at a normal temperature. The temperature can be driving temperature of panel and be measured temperature sensor positioned around the panel.

The high temperature can be a value more than 40° C., the low temperature can be a value less than 20° C. And, the normal temperature can be a value between 20° C. and 40° C.

It is desirable that a safe signal (SAFE) is supplied in one or two subfields among a plurality of subfields divided for driving one frame. Also, local flickering phenomenon can be reduced by supplying a safe signal SAFE in less than two subfields.

It is desirable that a rising voltage V₃ of the safe signal SAFE is about 160 V to 210 V. When the rising voltage V₃ is in the above range, the bright defect generation can be reduced within a range that greatly increases the power consumption, and the flickering phenomenon can be improved.

It is desirable that the number of subfields where the safe signal (SAFE) is supplied among a plurality of subfields is about one to three. In the address period, a negative scan signal is supplied to the scan electrodes Y, sequentially, and a positive data signal is supplied to the address electrodes X at the same time. When the voltage difference between the scan signal and the data signal and the wall voltage generated during the setup period are added, address discharge is induced in cells where the data signal is supplied. The address discharge induces a wall charge in the cells selected by the address discharge. The address discharge can be stably induced because the safe signal (SAFE) induces a negative wall charge at the scan electrode Y formed at all discharge cells. Accordingly, flickering phenomenon and bright defect generation can be prevented.

It is desirable to supply a bias voltage Vzb to a sustain electrode during the address period. Also, it is desirable that the bias voltage Vzb is about 140V to 190V. When the bias voltage Vzb is in the above range, the flickering phenomenon is not generated, and the luminance is improved.

It is desirable that the voltage of the scan signal is about −130V to −90V. When the scan signal is in the above voltage range, the flickering phenomenon and the bright defect are not generated. Also, a black luminance of a displayed image is improved.

The scan signals can be different in width in at least one of subfields. For example, the width of a scan signal in a following subfield can be narrower than the width of a scan signal in an advanced subfield in a time domain. The width of the scan signal can gradually falling depending on an order of arranging the subfields, for example, 2.6 us, 2.3 us, 2.1 us, . . . , 1.9 us or 2.6 us, 2.3 us, 2.3 us, 2.1 us, . . . , 1.9 us, and 1.9 us.

The width of scan signal is reduced as the location of subfields goes to the back. Then, the width of scan signal can increase again after a predetermined subfield.

In the sustain period, a sustain discharge is induced as a surface discharge type between a scan electrode (Y) and a sustain electrode (Z) by alternatively supplying a sustain pulse to a scan electrode and a sustain electrode.

In FIGS. 5A and 5B, driving waveforms are signals for driving a plasma display panel according to one exemplary embodiment of the present invention. The driving waveforms of FIGS. 5A and 5B are not intended to limit the scope of present invention. For example, a pre-reset period can be further included for inducing a positive wall charge on scan electrodes (Y) and forming a negative wall charge on sustain electrode (Z). The pre-reset period is present prior to a reset period of the first subfield in each frame. In the pre-reset period, a negative voltage is supplied to a scan electrode and a positive voltage is supplied to a sustain electrode for inducing a discharge between the scan electrode and the sustain electrode. Herein, the negative voltage supplied to the scan electrode can gradually decrease. The positive voltage can be supplied to a scan electrode, and the negative voltage can be supplied to a sustain electrode.

Polarities and voltage levels of the driving signals shown in FIGS. 5A and 5B can change if it is necessary. After completion of the sustain discharge, an erase signal can be supplied to the sustain electrode for erasing the wall charge. Also, possible is single sustain driving in which that the sustain signal is supplied only to either the scan electrode (Y) or the sustain electrode (Z), thereby inducing the sustain discharge.

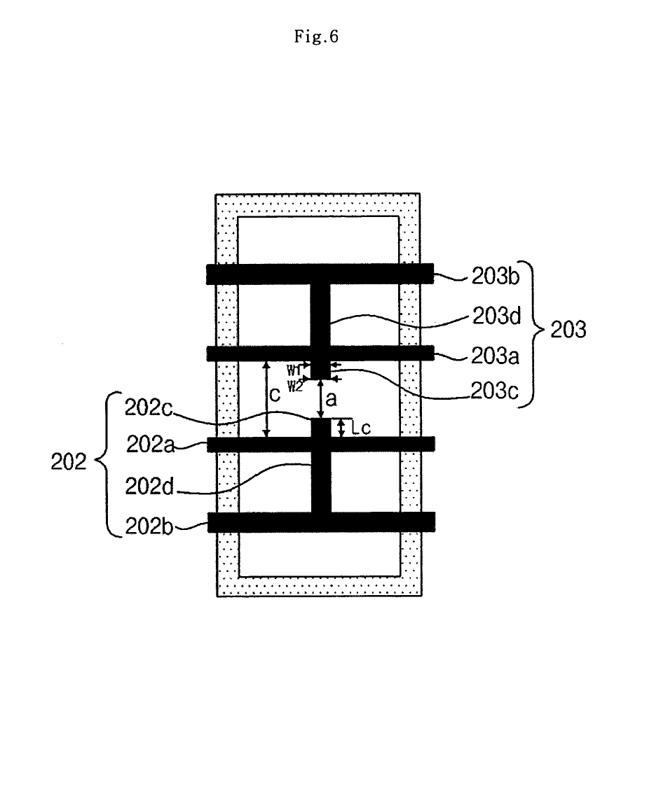

FIG. 6 is a cross-sectional view illustrating a sustain electrode structure of a plasma display panel according to a first embodiment of the present invention. FIG. 6 schematically shows a simple arrangement structure of a sustain electrode pair 202 and 203 within a discharge cell of the plasma display panel of FIG. 2.

As shown in FIG. 6, the sustain electrodes 202 and 203 are symmetrically paired on the basis of a center of a discharge cell on a substrate according to the first exemplary embodiment of the present invention. Each of the sustain electrodes 202 and 203 includes a line part having at least two of electrode lines 202a, 202b, 203a and 203b crossing the discharge cells, and a protrusion part having at least one of protrusion electrodes 202c and 203c which are connected to electrode lines 202a and 203a closest to the center of a discharge cell, and protruding in the direction of the center of the discharge cell within the discharge cell. As shown in FIG. 6, it is desirable that each of the sustain electrodes may further include one bride electrode 202d or 203d for connecting the two electrode lines.

The electrode lines 202a, 202b, 203a and 203b cross the discharge cells and extend in one direction of the plasma display panel. As described above, a same driving pulse is supplied to discharge cells on the same electrode line. According to the first embodiment, the electrode lines are narrowed in width to improve an aperture ratio. Also, a plurality of electrode lines 202a, 202b, 203a and 203b are used to improve a discharge diffusion efficiency. It is desirable that the number of the electrode lines is decided in consideration of the aperture ratio.

It is desirable that the protrusion electrodes 202c and 203c are connected to electrode lines 202a and 203a closest to the center of a discharge cell within one discharge cell, and protrude in the direction of the center of the discharge cell. The protrusion electrodes 202c and 203c reduce a discharge initiation voltage when the plasma display panel is driven. By a distance between electrode lines 202a and 203a, the discharge initiation voltage increases and therefore, each of the electrode lines 202a and 203a has the protrusion electrode 202c or 203c connecting thereto in the first exemplary embodiment of the present invention. Since a discharge is initiated owing to even a low discharge initiation voltage between the closely formed protrusion electrodes 202c and 203c, the discharge initiation voltage of a plasma display panel can be reduced. The discharge initiation voltage refers a voltage level where the discharge is initiated when a pulse is supplied to at least one of the sustain electrodes 202 and 203.

Since the protrusion electrodes are a very small size, a width (W1) of a protrusion electrode portion connecting with the electrode line 202a or 203a may be substantially greater than a width (W2) of the protrusion electrode end portion by a manufacture tolerance. It is also possible to provide the width of the protrusion electrode end portion greater according to need.

The bridge electrodes 202d and 203d connect electrode lines of each sustain electrode. That is, the first bridge electrode 202d connects the electrode lines 202a and 202b of the first sustain electrode 202 each other. The second bridge electrode 203d connects the electrode lines 203a and 203b of the second sustain electrode 203 each other. The bridge electrodes 202d and 203d help a discharge initiated through the protrusion electrode to easily diffuse to electrode lines 202b and 203b which are distant away from the center of the discharge cell.

As described above, the electrode structure according to the first embodiment can suggest the number of the electrode lines, thereby improving the aperture ratio. The electrode structure according to the first embodiment also includes the protrusion electrodes, thereby reducing the discharge initiation voltage. Furthermore, the electrode structure according to the first embodiment can improve the electric discharge diffusion efficiency by the electrode lines distant away from the center of the discharge cell. In overall, the electrode structure according to the first embodiment improves the luminous efficiency of a plasma display panel.

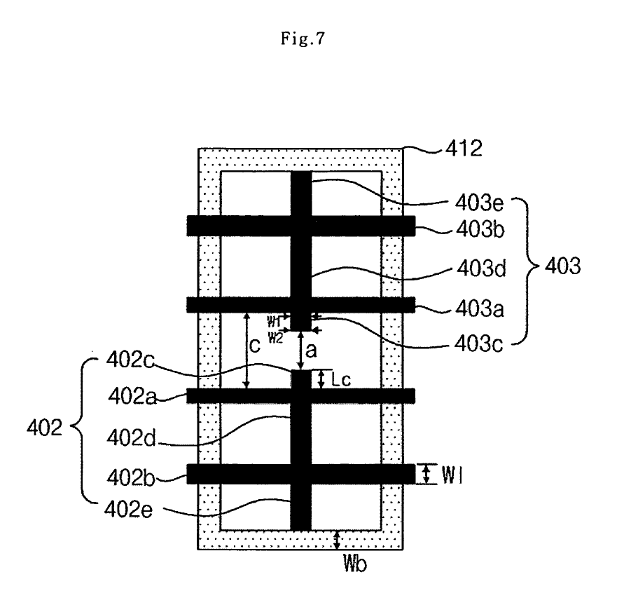

FIG. 7 is a cross-sectional view illustrating a sustain electrode structure according to a second embodiment of the present invention. The sustain electrodes 402 and 403 according to the second embodiment is paired in a discharge cell on a substrate. Each of the sustain electrodes 402 and 403 includes at least two of electrode lines 402a, 402b, and 403a, 403b crossing discharge cells, one of first protrusion electrode 402c and 403c connected to electrodes 402a and 403a closest to the center of a corresponding discharge cell and protruding in a center direction of the discharge cell within a discharge cell, one of bridge electrodes 402d and 403d connecting the two electrode lines, and one of second protrusion electrodes 402e and 403e connected electrode lines 402b and 403b most distant away from the center of the discharge cell and protruding in an opposition direction of the center of the discharge cell within the discharge cell.

The electrode lines 402a, 402b, and 403a, 403b cross the discharge cells, and extend in one direction of the plasma display panel. The electrode lines according to the second embodiment are formed to be narrower in width for improving an aperture ratio. It is desirable that the electrode lines have the width (W1) of about 20 μm and 70 μm for improving the aperture ratio and for smoothly inducing discharging at the same time.

As shown in FIG. 7, the electrode lines 402a and 403a close to the center of the discharge cell are connected to the first protrusion electrode 402c and 403c. The electrode lines 402a and 403a also form a path where the discharge is initiated and the same time, a discharge diffusion begins. The electrode lines 402b and 403b distant away from the center of the discharge cell are connected with the second protrusion electrodes 402e and 403e. The electrode lines 402b and 403b diffuse the discharge up to a peripheral part of the discharge cell.

The first protrusion electrodes 402c and 403c are connected to the electrode lines 402a and 403a close to the center of the discharge cell within one discharge cell. The first protrusion electrodes 402c and 403c protrude in the center direction of the discharge cell. It is desirable that the first protrusion electrode is formed at the center of the electrode lines 402a and 403a. By forming the first protrusion electrodes 402c and 403c at the center of the electrode lines correspondingly to each other, the discharge initiation voltage of the plasma display panel can be more effectively lowered.

The bridge electrodes 402d and 403d are connected to electrode lines of each of the sustain electrode. The bridge electrodes 402d and 403d help the discharge initiated by the protrusion electrode to easily diffuse to the electrode lines 402b and 403b distant away from the center of the discharge cell. The bridge electrode 402d and 403d are placed within the discharge cell. However, the bridge electrodes can be also formed on a barrier rib 412 partitioning the discharge cells according to need.

The second protrusion electrodes 402e and 403e are connected to the electrode lines 402b and 403b distant away from the center of the discharge cell within one discharge cell. The second protrusion electrodes 402e and 403e protrude in an opposite direction from the center of the discharge cell. Accordingly, in the sustain electrode structure of the plasma display panel according to the second embodiment, the discharge can be diffused even to a space between the electrode lines 402b and 403b and the barrier ribs 413. Thus, the discharge diffusion efficiency can increase, thereby improving the light emission efficiency of the plasma display panel.

The second protrusion electrodes 402e and 403e can extend to the barrier ribs 412 partitioning the discharge cells. If the aperture ratio can be sufficiently compensated from other portion, it is possible to further extend a portion of the second protrusion electrodes 402e and 403e over the barrier ribs 412 in order to more improve the discharge diffusion efficiency. In the sustain electrode structure according to the second embodiment, it is desirable that the second protrusion electrodes 402e and 403e are formed on the center of the electrode lines 402b and 403b, thereby uniformly diffusing the discharge to the peripheral part of the discharge cell.

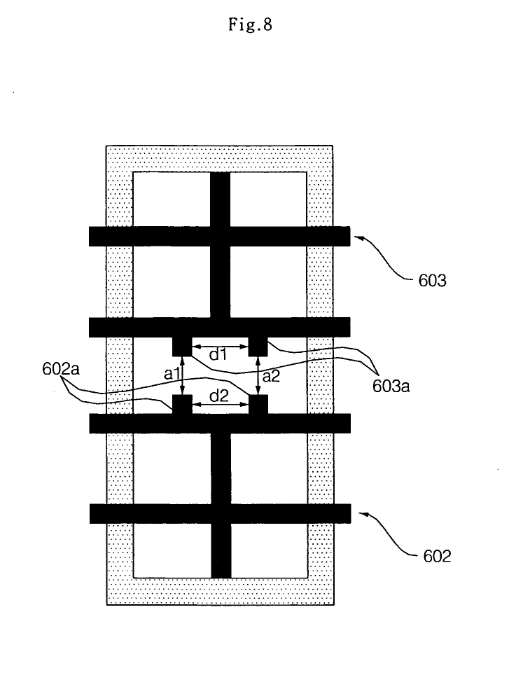

FIG. 8 is a cross-sectional view illustrating a sustain electrode structure according to a third embodiment of the present invention. A description of the same content of the sustain electrode structure of FIG. 8 as that of FIG. 7 will be omitted.

As shown in FIG. 8, in the sustain electrode structure according to the third embodiment, two first protrusion electrodes 602c and 603c are formed at each of sustain electrodes 602 and 603. The first protrusion electrodes 602a and 603a connected to electrode lines 402a and 403a close to a center of the discharge cell, and protrude in the direction of the center of the discharge cell. It is desirable that the first protrusion electrode 602a and 603a are formed in symmetry with each other on the basis of a center of electrode line.

By forming the two first protrusion electrodes at the sustain electrodes, the size of the sustain electrode at the center of the discharge cell is widened. Accordingly, space charges are sufficiently formed within the discharge cell before the discharge is initiated. Thus, the discharge initiation voltage is further lowered and a discharging speed is fastened. Furthermore, the amount of wall charge increases after the discharge is initiated. Therefore, the luminance thereof is improved, and the discharge is uniformly diffused throughout the entire discharge cells.

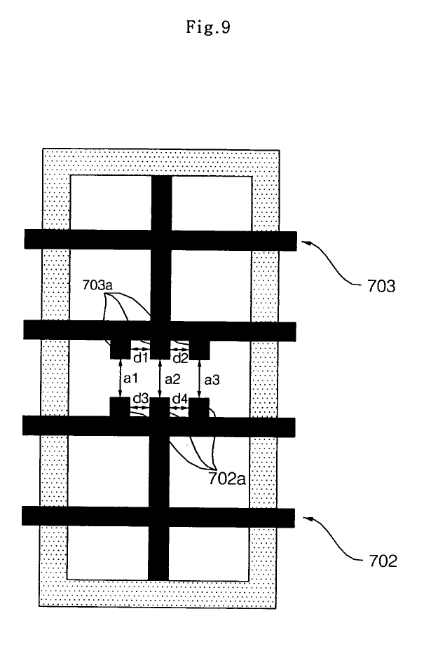

FIG. 9 is a cross-sectional view of a sustain electrode according to a fourth embodiment of the present invention. A description of the same content of the sustain electrode structure of FIG. 9 as those of FIGS. 7 and 8 will be omitted.

As shown in FIG. 9, three first protrusion electrodes 702a and 703a are formed at each of the sustain electrodes 702 and 703, respectively in the sustain electrode structure according to the fourth embodiment of the present invention.

The first protrusion electrodes 702c and 703c are connected to the electrode lines 402a and 403a close to the center of a discharge cell in one discharge cell, and protruding in a direction to the center of the discharge cell. It is desirable that one of the first protrusion electrodes is formed at a center of electrode line, and other two first protrusion electrodes are formed in symmetry with each other on the basis of a middle of the electric line. By forming three protrusion electrodes at each of the sustain electrodes, the discharge initiation voltage can be further lowered, and the discharging speed is more fastened compared to those in FIG. 7 and FIG. 8. Furthermore, the amount of wall charge increases after the discharge is initiated. Therefore, the luminance thereof is improved, and the discharge is uniformly diffused throughout the entire discharge cells.

As the number of the first protrusion electrodes increases as above, the size of sustain electrode at the center of a discharge cell is widened, the discharge initiation voltage is lowered, and the luminance thereof improved. On the contrary, it should be considered that the strongest discharge is induced and the brightest discharge light is emitted at the center of the discharge cell. That is, it is desirable that the number of the first protrusion electrodes is optimally selected and the sustain electrode structure is designed, considering, together with the discharge initiation voltage and the luminance efficiency, that the light emitted from the center of the discharge cell is much blocked and remarkably reduced as the number of the first protrusion electrodes increases.

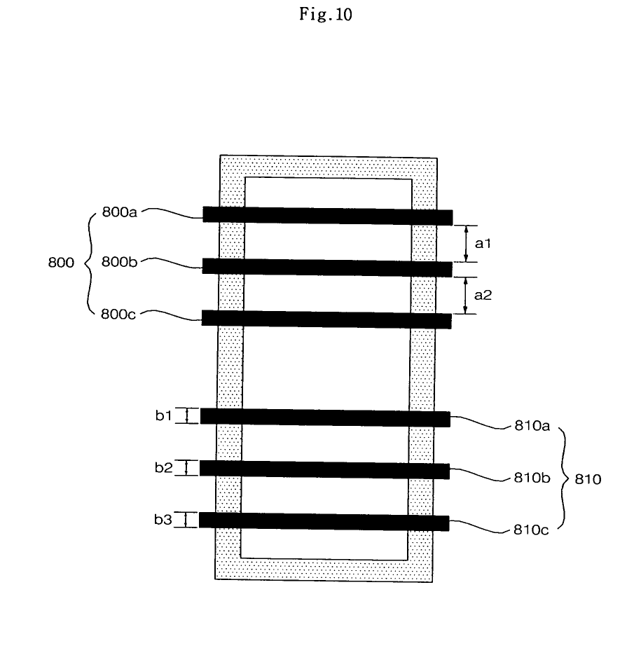

FIG. 10 is a cross-sectional view illustrating an electrode structure of a plasma display panel according to a fifth embodiment of the present invention. Each of the sustain electrode 800 and 810 includes three electrode lines 800a, 800b, 800c, 810a, 810b, and 810c, respectively. The electrode lines cross the discharge cells and extend in one direction of a plasma display panel. The electrode lines are narrowed in width to improve an aperture ratio. It is desirable that the electrode lines have a width of about 20 μm to 70 μm so as to improve the aperture ratio and to smoothly induce a discharge.

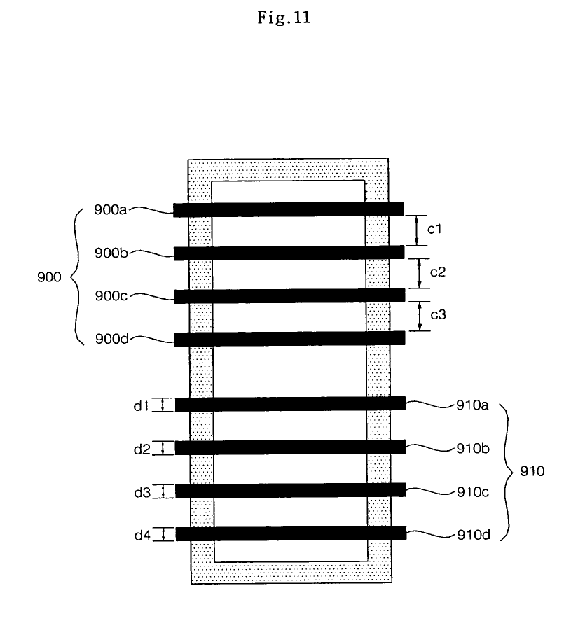

FIG. 11 is a cross-sectional view illustrating an electrode structure of a plasma display panel according to a sixth embodiment of the present invention. Each of the sustain electrode 900 and 910 includes four electrode lines 900a, 900b, 900c, 900d, and 910a, 910b, 910c, 910d, respectively. The electrode lines cross the discharge cells and extend in one direction of a plasma display panel. The electrode lines are narrowed in width to improve an aperture ratio. It is desirable that the electrode lines have a width of about 20 μm to 70 μm so as to improve the aperture ratio and to smoothly induce a discharge.

Intervals (c1, c2 and c3) between the four electrode lines constituting each of the sustain electrodes can be equal to or different from each other. Widths (d1, d2, d3 and d4) of the electrode lines can be equal to or different from each other.

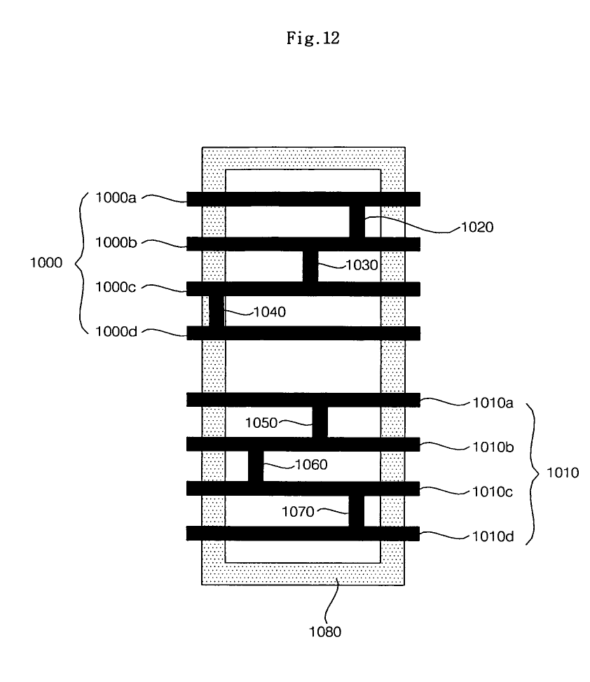

FIG. 12 is a cross-sectional view illustrating an electrode structure of a plasma display panel according to a seventh embodiment of the present invention. Each of the sustain electrode 1000 and 1010 includes four electrode lines 1000a, 1000b, 1000c, 1000d, and 1010a, 1010b, 1010c, 1010d, respectively. The electrode lines cross the discharge cells and extend in one direction of a plasma display panel.

Bridge electrodes 1020, 1030, 1040, 1050, 1060, and 1070 connect corresponding two electrode lines, respectively. The bridge electrodes 1020, 1030, 1040, 1050, 1060, and 1070 make an initiated discharge to easily diffuse to the electrode line distant away from a center of the discharge cell. As shown in FIG. 12, the bridge electrodes 1020, 1030, 1040, 1050, 1060, and 1070 may not be consistent with each other in position, and any one of the bridge electrodes, for example, bridge electrode 1040, may be formed on the barrier rib 1080.

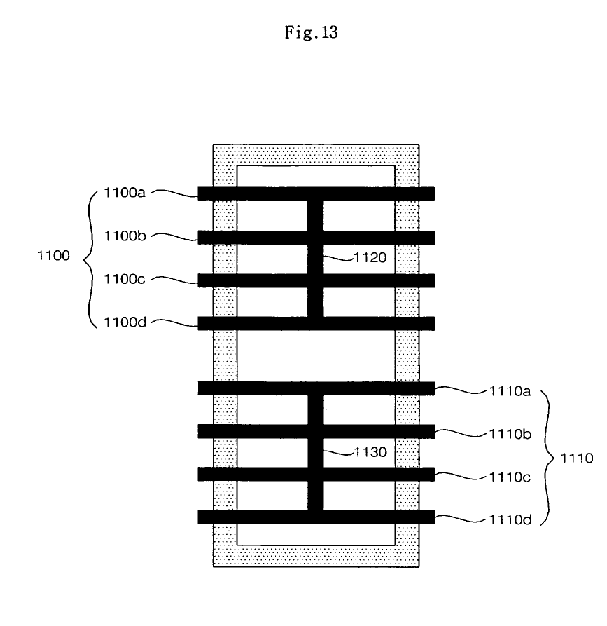

FIG. 13 is a cross-sectional view illustrating an electrode structure of a plasma display panel according to an eighth embodiment of the present invention. Unlike the bridge electrode structure in FIG. 12, bridge electrodes are formed in the same position. The bridge electrodes 1120 and 1130 are formed at sustain electrodes 1100 and 1110, respectively, to connect corresponding four electrode lines 1100a, 1100b, 1100c, 1100d, and 1110a, 1110b, 1110c, 1110d.

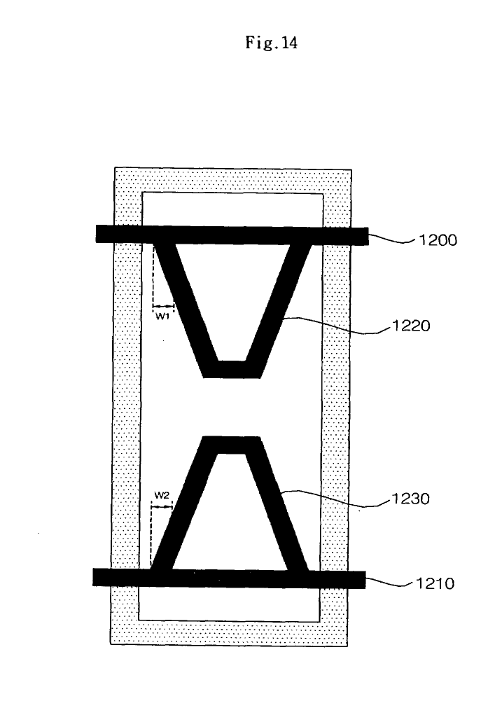

FIG. 14 is a cross-sectional view illustrating an electrode structure of a plasma display panel according to a ninth embodiment of the present invention. A protrusion electrode 1220 or 1230 having a closed loop shape is formed at each of electrode lines 1220 and 1230. As shown in FIG. 14, a discharge initiation voltage can be lowered, and an aperture ratio is also improved at the same time through the closed loop shaped protrusion electrodes 1220 and 1230. The closed loop shape of the protrusion electrode can be variously modified in shape.

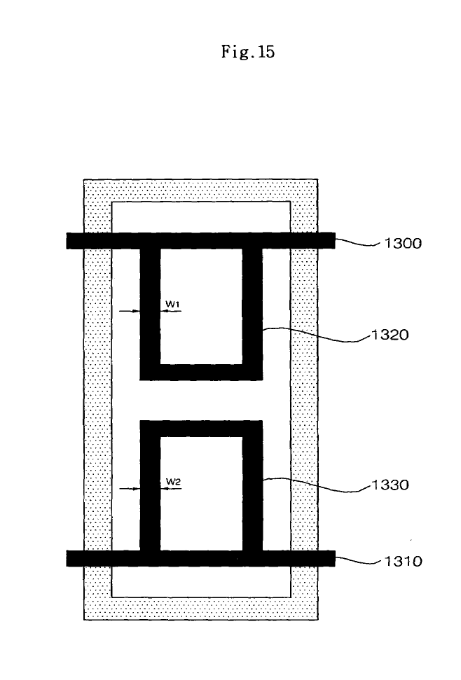

FIG. 15 is a cross-sectional view illustrating an electrode structure of a plasma display panel according to a tenth embodiment of the present invention. Electrode lines 1300 and 1310 include protrusion electrodes 1320 and 1330 having rectangle shaped closed loops.

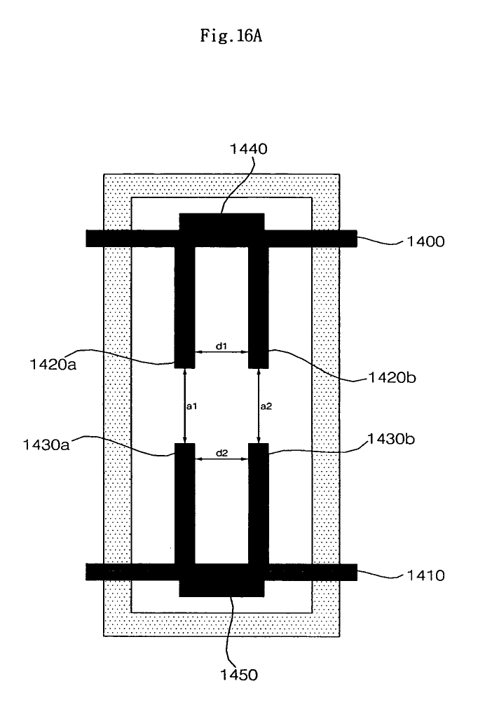

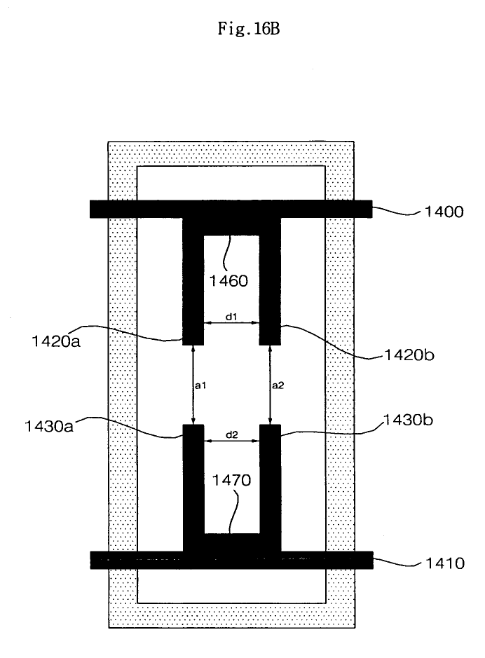

FIGS. 16A and 16B are cross-sectional views illustrating an electrode structure of a plasma display panel according to an eleventh embodiment of the present invention. Each of electrode lines 1400 and 1410 includes first protrusion electrodes 1420a, 1420b, 1430a and 1430b protruding in a direction to a center of each discharge cell, and second protrusion electrodes 1440, 1450, 1460 and 1470 protruding in an opposite direction of the center of the discharge cell or in the direction thereof, respectively.

As shown in FIG. 16A, it is desirable that each of the electrode lines 1400 and 1410 includes the two first protrusion electrodes 1420a, 1420b, and 1430a 1430b protruding in the direction of the center of the discharge cell, and the one second protrusions 1440 or 1450 protruding in the opposite direction of the center of the discharge cell. Alternatively, as shown in FIG. 16B, the second protrusion electrodes 1460 and 1470 can also protrude in the direction of the center of the discharge cell.

As described above, the transparent electrode formed of ITO can be eliminated from the plasma display panel of the plasma display apparatus according to the present invention. Thus, a manufacturing cost of the plasma display panel can be reduced. The plasma display panel according to the present invention includes the protrusion electrodes protruding from the scan electrode or the sustain electrode line in the direction of the center of the discharge or in the opposite direction thereof. Accordingly, the discharge initiation voltage can be reduced and the discharge diffusion efficiency can be enhanced. Furthermore, the gradually rising safe signal is supplied after supplying the reset signal twice in the plasma display panel according to the present invention. Therefore, flickering phenomenon and bright defect generation are reduced, thereby improving an image quality.

The foregoing exemplary embodiments and aspects of the invention are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A plasma display apparatus comprising:
an upper substrate;
a scan electrode and a sustain electrode formed on the upper substrate;
a dielectric layer covering the scan electrode and the sustain electrode;
a lower substrate facing the upper substrate; and
address electrodes formed on the lower substrate,
wherein at least one of the scan electrode and the sustain electrode is formed as one layer, and
wherein in at least one reset period among a plurality of subfields, a reset signal including a gradually falling setdown period is supplied to the scan electrode more than two times.

2. The plasma display apparatus of claim 1, wherein the reset signal includes a gradually rising setup period.

3. The plasma display apparatus of claim 1, wherein in at least one reset period among a plurality of subfields, a first reset signal and a second reset signal are sequentially supplied to the scan electrode, where the first resent signal includes a first setup period gradually rising and a first setdown period gradually falling, and the second reset signal includes a second setup period gradually rising and a second setdown period gradually falling.

4. The plasma display apparatus of claim 1, wherein at least one of the scan and sustain electrodes comprises:
a line part formed in the direction of intersecting with the address electrodes; and
a protrusion part protruding from the line part.

5. The plasma display apparatus of claim 3, wherein maximum voltages of the first and second reset signals are different from each other.

6. The plasma display apparatus of claim 1, wherein the address electrode inside a discharge cell is larger than the address electrode outside the discharge cell in width.

7. The plasma display apparatus of claim 1, further comprising:
a first barrier rib formed in the direction of intersecting with the address electrodes on the lower substrate; and
a second barrier rib formed in the direction of intersecting with the first barrier rib,
wherein the heights of the first and second barrier ribs are different from each other.

8. The plasma display apparatus of claim 1, further comprising phosphor layers formed on the lower substrate,
wherein thicknesses of the phosphor layers of first and second discharge cells among a plurality of discharge cells emitting different colors are different from each other.

9. A plasma display apparatus comprising:
an upper substrate;
a scan electrode and a sustain electrode formed on the upper substrate;
a dielectric layer covering the scan and sustain electrodes;
a lower substrate facing the upper substrate; and
address electrodes formed on the lower substrate,
wherein at least one of the scan electrode and the sustain electrode is formed as one layer, and
wherein in at least one reset period among a plurality of subfields, after supplying a reset signal having a gradually falling setdown period to the scan electrode more than once, a first signal rising as much as a first voltage is supplied to the scan electrode before a scan signal having a negative voltage is supplied to the scan electrode.

10. The plasma display apparatus of claim 9, wherein at least one of the scan electrode and the sustain electrode comprises:
a line part formed in the direction of intersecting with the address electrodes; and
a protrusion part protruding from the line part.

11. The plasma display apparatus of claim 9, wherein the first signal is gradually rising as much as about 160V to 220V.

12. The plasma display apparatus of claim 9, wherein the first signal is provided in less than three subfields.

13. A plasma display apparatus comprising:
an upper substrate;
a scan electrode and a sustain electrode formed on the upper substrate;
a dielectric layer covering the scan and sustain electrodes;
a lower substrate facing the upper substrate; and
address electrodes formed on the lower substrate,
wherein at least one of the scan and sustain electrodes is formed as one layer,
wherein in at least one reset period among a plurality of subfields, a reset signal having a gradually rising setup period is supplied to the scan electrode more than once, and
wherein in at least one reset period among the plurality of subfields, the gradually rising setup period is not supplied to the scan electrode.

14. The plasma display apparatus of claim 13, wherein the reset signal includes a gradually falling setdown period.

15. The plasma display apparatus of claim 13, wherein a predetermined voltage is supplied to the address electrode in at least one of reset periods among the plurality of subfields.

16. The plasma display apparatus of claim 13, wherein at least one of the scan electrode and the sustain electrode comprises:
a line part formed in the direction of intersecting with the address electrode; and
a protrusion part protruding from the line part.

17. The plasma display apparatus of claim 13, wherein a maximum voltage of the reset signal at a high temperature and a low temperature is higher than a maximum voltage of the reset signal at a normal temperature.

18. The plasma display apparatus of claim 13, wherein in at least one of reset periods among the plurality of subfields, a reset signal having a gradually falling setdown period is supplied to the scan electrode more than one time, and a first signal rising as much as a first voltage before a scan signal having a negative voltage is supplied to the scan electrode.

19. The plasma display apparatus of claim 13, further comprising:
a first barrier rib formed in the direction of interacting with the address electrode on the lower substrate; and
a second barrier rib formed in the direction of intersecting with the first barrier rib,
wherein the heights of the first and second barrier ribs are different.

20. The plasma display apparatus of claim 13, further comprising phosphor layers formed on the lower substrate,
wherein thicknesses of the phosphor layers of first and second discharge cells among a plurality of discharge cells emitting different colors are different from each other.

21. The plasma display apparatus of claim 13, wherein the reset period is omitted in the first subfield.
